(19) United States
(12) Patent Application Publication
(10) Pub. No.: US 2015/0071146 A1
(43) Pub. Date: Mar. 12, 2015

(54) Aperiodical Discovery Channel Design for Small RRHS

(71) Applicants: Na Wei, Beijing (CN); Wei Bai, Beijing (CN); Gilles Charbit, Farnborough (GB); Wei Hong, Beijing (CN); Erlin Zeng, Beijing (CN); Pengfei Sun, Beijing (CN); Haiming Wang, Beijing (CN)

(72) Inventors: Na Wei, Beijing (CN); Wei Bai, Beijing (CN); Gilles Charbit, Farnborough (GB); Wei Hong, Beijing (CN); Erlin Zeng, Beijing (CN); Pengfei Sun, Beijing (CN); Haiming Wang, Beijing (CN)

(73) Assignee: Broadcom Corporation, Irvine, CA (US)

(21) Appl. No.: 14/380,860

(22) PCT Filed: Feb. 23, 2012
(86) PCT No.: PCT/CN2012/071519

§ 371 Date: Aug. 25, 2014

(51) Int. Cl. H04W 72/12; H04W 8/00; H04W 52/02

(52) U.S. Cl. CPC H04W 72/12; H04W 52/0209; H04W 8/005
USPC 370/311

(57) ABSTRACT

An apparatus and a method is provided by which it is determined that at least one user equipment should perform detection and/or measurements with respect to at least one network control node, the at least one network control node is instructed to send a predetermined aperiodic signal to the at least one user equipment, and the at least one user equipment is instructed to detect the predetermined aperiodic signal.

### FIELD OF THE INVENTION

The present invention relates to methods, devices and computer program products for providing an aperiodical discovery channel design, for example in a network system comprising small RRHs (remote radio heads).

### BACKGROUND

The following meanings for the abbreviations used in this specification apply:

### 3GPP 3^{rd} Generation Partnership Project

### A-PDCH Aperiodical Physical Discovery Channel

### AoA Angle-of-Arrival.

### CA Carrier Aggregation

### CRS Common Reference Signal

### CSG Closed Subscriber Group

### DoA Direction of Arrival

### DL Downlink

### eNB Enhanced Node B. Name for Node B in LTE

### LTE Long Term Evolution

### LTE-A Long Term Evolution Advanced

### PCell Primary Cell

### PDCH Physical Discovery Channel

### PDCCH Physical Downlink Control Channel

### PSS Primary Synchronization Signal

### RRC Radio Resource Control

### RRH Remote Radio Head

### RSRP Reference Signal Received Power

### SCell Secondary Cell

### SSS Secondary Synchronization Signal

### TA Timing Advance

### UE User Equipment

### UL Uplink

Embodiments of the present invention relate to LTE-Advance, and in particular to Carrier Aggregation. Carrier Aggregation (CA) in LTE-Advanced extends the maximum bandwidth in the Uplink (UL) or Downlink (DL) directions by aggregating multiple carriers within a frequency band (intra-band CA) or across frequency bands (inter-band CA). In Rel-11, a new carrier type was agreed as a Work Item in [1]. Such new carrier type does not need to be backward compatible. Because this new type of carrier does not necessarily be usable by legacy UE, some enhancement could be supported on it, e.g. to reduce the density or even re-design the reference signal to save overhead, to do some optimization to suit some specific application scenarios. Currently, new carrier type discussions in RAN1 mainly focus on the need of a certain kind of reference signals, and the design of each reference signal.

Moreover, 3GPP RAN2 has an ongoing SI, “Study on Hetnet mobility enhancements for LTE.” One of its tasks is to identify and evaluate strategies for improved small cell discovery/identification [2]. Quite some proposals are contributed and discussed from RAN2's point of view [3]-[5]. However, it has been proposed in a discussion paper that those RAN2 methods may not be able to solve the problem entirely, and it seems the operators are also interested in considering the quick cell identification for a RRH scenario using the new carrier type [6]. In such scenario, it is assumed that macro eNB will be configured as UE's PCell, and the small RRH will be configured as SCell.

An example for such a RRH scenario is shown in FIG. 6. FIG. 6 illustrates three macro cells which are controlled by macro eNBs, namely eNB1, eNB2 and eNB3. In the coverage of eNB1, five RRHs are present, namely RRH1-1, RRH1-2, RRH1-3, RRH1-4 and RRH1-5. In the coverage of eNB2, also five RRHs are present, namely RRH2-1, RRH2-2, RRH2-3, RRH2-4 and RRH2-5. Furthermore, also in the coverage of eNB3, five RRHs are present, namely RRH3-1, RRH3-2, RRH3-3, RRH3-4 and RRH3-5. Hence, when a UE is located in the coverage of RRH1-1, for example, the RRH1-1 can be configured as the SCell of the UE, and the eNB1 can be configured as the PCell of the UE.

The new physical channel proposed in [6] referred to as the Physical Discovery Channel (PDCH) has long periodicity (i.e. a few seconds assuming relaxed measurement requirements for energy saving and low mobility and sufficient time/frequency radio resource density for one-shot PDCH reception by the UE for efficient UE battery consumption (e.g. full use of a few subframes). However, it may introduce larger access/detection delay due to long periodicity of DPCH. If we just reduce the periodicity, the advantages of PDCH such as low power consumption might be gone.

Thus, it is worth to further consider how to perform efficiently PDCH transmission in order to provide better tradeoff of power consumption and delay of detection.

### REFERENCES

[1] RP-110451, WI Proposal: LTE CA enhancements, Nokia Corporation, Nokia Siemens Networks
[2] RP-110709, WI Proposal: Study on Hetnet mobility enhancements for LTE
[3] R2-115745 Inter-frequency Pico cell measurements for Hetnet deployments, NTT DoCoMo
[4] R2-114951 Discussion on enhancement of small cell discovery, ZTE
[5] R2-115139 Enhancement of proximity indication in heterogeneous networks, Renesas Mobile
[6] R1-114071 Issues Regarding Additional Carrier Type in Rel-11 CA, NTT DoCoMo

### SUMMARY

The present invention addresses such situation and aims to provide an improved PDCH transmission which reduces power consumption of a user equipment and delay of detection.

Various aspects of examples of the invention are set out in the claims.

According to a first aspect of the present invention, there is provided an apparatus which comprises at least one processor; and at least one memory including computer program code; the at least one memory and the computer program being configured to, with the at least one processor, cause the apparatus to determine that at least one user equipment should perform detection and/or measurements with respect to at least one network control node; send instruction to the at least one network control node to send a predetermined aperiodic signal to the at least one user equipment; and send instruction to the at least one user equipment to detect the predetermined aperiodic signal.

According to a second aspect of the present invention, there is provided an apparatus which comprises at least one processor; and at least one memory including computer program code; the at least one memory and the computer program being configured to, with the at least one processor, cause the apparatus to receive an instruction from a network control node to send a predetermined aperiodic signal to at least one user equipment; and send the predetermined aperiodic signal to at the least one user equipment.

According to a third aspect of the present invention, there is provided an apparatus which comprises at least one processor; and at least one memory including computer program code; the at least one memory and the computer program being configured to, with the at least one processor, cause the apparatus to receive an instruction to detect a predetermined aperiodic signal sent by a network control node; and attempt to detect the predetermined aperiodic signal.

According to a fourth aspect of the present invention, there is provided a method which comprises determining that at least one user equipment should perform detection and/or measurements with respect to at least one network control node; sending instruction to the at least one network control node to send a predetermined aperiodic signal to the at least one user equipment; and sending instruction to the at least one user equipment to detect the predetermined aperiodic signal.

According to a fifth aspect of the present invention, there is provided a method which comprises receiving an instruction from a network control node to send a predetermined aperiodic signal to at least one user equipment; and sending the predetermined aperiodic signal to at the least one user equipment.

According to a sixth aspect of the present invention, there is provided a method which comprises receiving an instruction to detect a predetermined aperiodic signal sent by a network control node; and attempting to detect the predetermined aperiodic signal.

Advantageous developments and modifications are defined in the dependent claims.

According to a seventh aspect of the present invention, there is provided a computer program product comprising computer-executable components which, when executed on a computer, are configured to carry out the methods as defined in any one of the fourth to sixth aspects and modifications thereof.

Thus, according to embodiments of the present invention, a predetermined aperiodic signal (e.g., an aperiodic PDCH) is sent in order to allow measurement and/or detection in connection with a network control node such as a RRH. In this way, the signal is only sent when needed, so that only minimum power in the UE for detecting the predetermined aperiodic signal is needed.

### BRIEF DESCRIPTION OF DRAWINGS

For a more complete understanding of example embodiments of the present invention, reference is now made to the following descriptions taken in connection with the accompanying drawings in which:

FIG. 1A to 1C schematically illustrate an eNB, a RRH and a UE according to embodiments of the present invention,

FIG. 2 shows a signaling flow according to an embodiment of the present invention,

FIG. 3 shows a signaling flow for a two-stage A-PDCH according to an embodiment of the present invention,

FIG. 4A and FIG. 4B show a more detailed example for the two-stage A-PDCH according to an embodiment of the present invention,

FIG. 5 shows an example for a combined use of a periodical PDCH and an aperiodical PDCH according to an embodiment of the present invention, and

FIG. 6 shows an example for a RRH scenario.

### DESCRIPTION OF EXEMPLARY EMBODIMENTS

Exemplary aspects of the invention will be described herein below.

It is to be noted that the following exemplary description refers to an environment of the LTE system (long term evolution) and/or local area networks thereof. However, it is to be understood that this serves for explanatory purposes only. Other systems differing from the LTE system can be adopted.

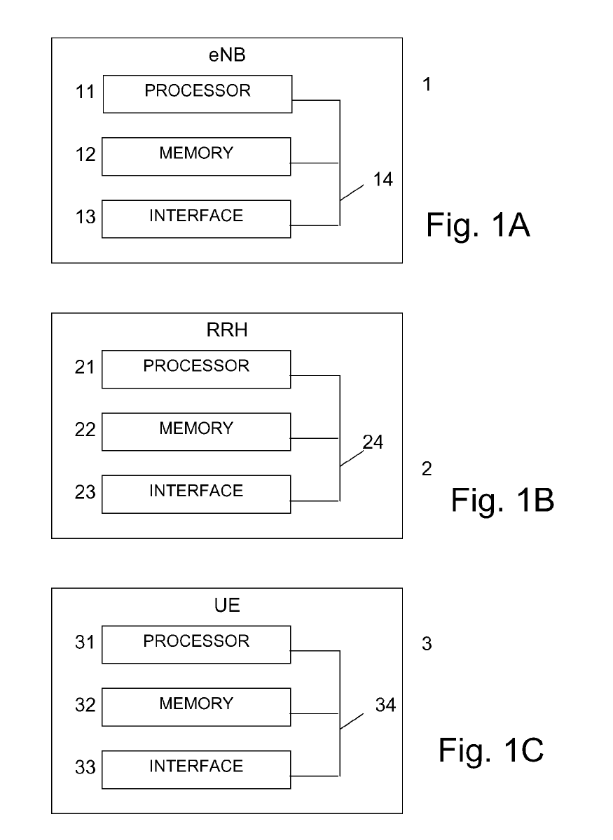

FIG. 1A illustrates a simplified block diagram of an eNB 1 as an example for a (master) network control node or macro node according to an embodiment of the present invention. It is noted that the eNB, and the corresponding apparatus according to the embodiment may consist only of parts of the eNB, so that the apparatus may be installed in an eNB, for example. Moreover, also the eNB is only an example and may be replaced by another suitable network element.

The eNB 1 according to this embodiment comprises a processor 11 and a memory 12. The memory comprises a computer program, wherein the memory 12 and the computer program are configured to, with the processor, cause the apparatus to determine that at least one user equipment should perform detection and/or measurements with respect to at least one network control node, send instruction to the at least one network control node to send a predetermined aperiodic signal to the at least one user equipment, and send instruction to the at least one user equipment to detect the predetermined signal.

Thus, according to this embodiment, the eNB instructs a network control node, which may be a slave network control node such as a RRH controlling a SCell, to send a predetermined aperiodic signal such as an aperiodic PDCH. In this way, the signal is only sent when needed, so that only minimum power in the UE for detecting the predetermined aperiodic signal is needed.

FIG. 1B illustrates a simplified block diagram of a RRH 2 as an example for a (slave) network control node or pico node according to an embodiment of the present invention. It is noted that the RRH, and the corresponding apparatus according to the embodiment may consist only of parts of the RRH, so that the apparatus may be installed in an RRH, for example. Moreover, also the RRH is only an example and may be replaced by another suitable network element.

The RRH 2 according to this embodiment comprises a processor 21 and a memory 22. The memory comprises a computer program, wherein the memory 22 and the computer program are configured to, with the processor, cause the apparatus to receive an instruction from a network control node to send a predetermined aperiodic signal to at least one user equipment.

FIG. 1C illustrates a simplified block diagram of a user equipment (UE) 3 according to an embodiment of the present invention. It is noted that the UE, and the corresponding apparatus according to the embodiment may consist only of parts of the UE, so that the apparatus may be installed in an UE, for example. Moreover, also the UE is only an example and may be replaced by another suitable network element.

The UE 3 according to this embodiment comprises a processor 31 and a memory 32. The memory comprises a computer program, wherein the memory 12 and the computer program are configured to, with the processor, cause the apparatus to receive an instruction to detect a predetermined aperiodic signal sent by a network control node.

Optionally, the eNB 1, the RRH 2 and the UE 3 may also respectively comprise an interface 13, 23 or 33 for providing connections to other network elements. Moreover, the processor 11, 21 or 31, the memory 12, 22 or 32, and the interface 13, 23, or 33 may be respectively inter-connected by a suitable connection 14, 24 or 34, e.g., a bus or the like. Moreover, it is noted that the apparatuses may comprise more than one processor, more than one memory and/or more than one interface, if this is suitable for a particular structure.

Thus, according to embodiments of the present invention, an aperiodical transmission is proposed in order to improve the performance of PDCH. That is, according to embodiments of the present invention, a new type of PDCH (aperiodical PDCH, also referred to as A-PDCH) is sent when a macro eNB specifically wishes the UE(s) to detect certain RRH(s) at certain time and resource. In this way, compared to a periodically sent PDCH, time and power can be saved.

Explicit trigger signaling may be used to inform UE about the A-PDCH via the eNB (macro cell).

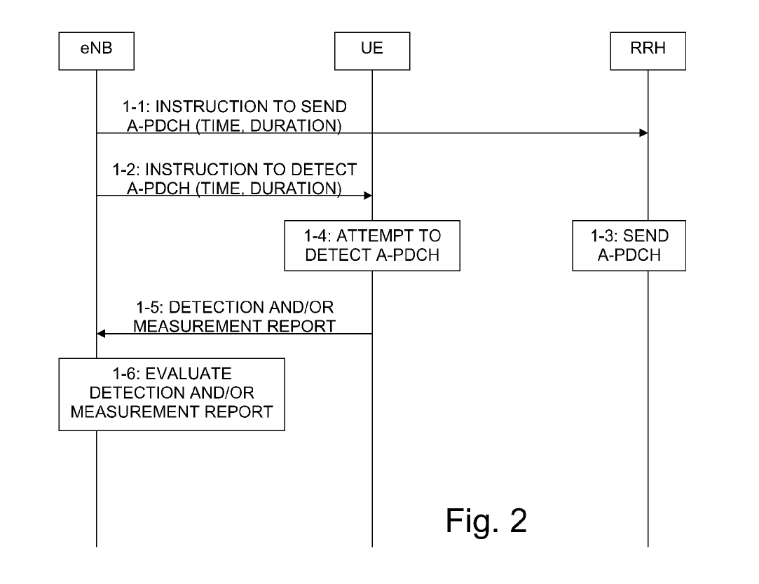

An example for this is illustrated by the signaling flow shown in FIG. 2.

When the eNB has determined that the UE should perform measurements with respect to the RRH, it sends in 1-1 instruction to the RRH to send an A-PDCH as an example for a predetermined aperiodic signal to the UE, and sends in 1-2 an instruction to the UE to detect the A-PDCH. The two instructions may include further information such as time (transmission time) and duration of the A-PDCH.

In 1-3, the RRH sends the A-PDCH, and in 1-4, the UE attempts to detect the A-PDCH. In 1-5, the UE sends a detection and/or measurement report to eNB, which may evaluate the detection and/or measurement report in 1-6.

In the above scenario, a plurality of UEs and/or a plurality of RRHs may be present. In this case, the eNB may select certain UEs of the plurality of UEs which are to detect the A-PDCH, and/or may select certain RRHs of the plurality of RRHs which are to send the A-PDCH.

Hence, by this kind of user-specific or group-specific aperiodical PDCH (A-PDCH) it can be achieved that the PDCH is only sent and to be detected when needed.

The A-PDCH may have the following properties:

The A-PDCH can be transmitted to a UE or a group of UE.

Some general/common configuration on aperiodical PDCH can be RRC signaled. The content of this configuration may include: A-PDCH duration per SCell, max number of SCell to detect in one A-PDCH window, a few predefined multiplexing patterns, RRH sets, etc.

Based on UE assistant info, or eNB's own measurement, such as AoA estimation, or UE's location information, the eNB may trigger aperiodical PDCH. The signaling may be L1/MAC/RRC. The signaling content may include: SCell index (or A-PDCH transmission pattern set index, Xi, and SCell index mask, SCell-index-mask of RRHs within set), numbers PDCH within this coming A-PDCH, PDCH type (SYNC only, MEAS only, or SYNC+MEAS), SCell A-PDCH transmission order, pattern index (how it is multiplexed, TDM/FDM or mixed), A-PDCH start timing.

Preferably, the eNB should coordinate the relevant RRH's A-PDCH transmission.

Upon receiving A-PDCH trigger, UE(s) will make detection and measurement accordingly.

The UE(s) send then the measurements to the eNB which will evaluate the measurements.

A-PDCH is assumed may contain SYNC part (synchronization part) and MEAS part (measurement part). The SYNC part contains some type of synchronization signal, which could be used by UE to make synchronization, detect the cell existence, and cell ID, etc. The MEAS part contains certain pilots which could be used by UE to make RRM measurement such as RSRP, RSRQ. The exact design is out of the scope of this document. Therefore A-PDCH could have three types, SYNC only, MEAS only, or SYNC+MEAS, which MEAS part follows immediately SYNC part.

In the following, an embodiment for a two-stage aperiodical PDCH design is described.

The two stage aperiodical PDCH design may further enhance the PDCH performance. In short, the eNB may, in stage 1, filter out not relevant RRHs, and transmit, in stage 2, measurement part only for relevant ones, so to save power/energy/time of UE.

For example it is assumed that the eNB maintains a RRH deployment mapping list from deployment, i.e., it has information about the location etc. of the RRHs. In case the eNB has intention to offload some traffic for some UE(s), but does not have sufficient knowledge of UE(s) location, it may perform two-stage A-PDCH transmission.

In stage 1, the eNB (macro eNB) configures one or more (m) RRHs to send SYNC part only of A-PDCH. SYNC part means that the A-PDCH contains only a synchronization part, that is, the UE(s) will have to detect only whether they can detect the A-PDCH or not, without further measurements. That is, an A-PDCH containing the SYNC part only is an example for a detection enabling signal, i.e., a signal by which a network node such as the UE is enabled to detect the RRH sending this signal.

Thus, the UE(s) will be configured to detect this A-PDCH, and will quickly feedback all the detectable RRHs without further measurement.

In stage 2, the eNB configures n (n<=m) RRHs to send SYNC+MEAS complete A-PDCH, or MEAS part only A-PDCH. That is, in stage 2 an A-PDCH is sent, which includes a measurement part based on which the UE may carry out further measurement. That is, an A-PDCH containing the MEAS part (and optionally also the SYNC part) is an example for a measurement enabling signal, i.e., a signal by which a network node such as the UE is enabled to carry out measurements with respect to the RRH sending this signal.

The UE(s) is/are configured to detect/measure the shortlisted RRHs' A-PDCH, i.e., the A-PDCH sent from the n RRHs.

It is noted that in stage 2, different UE(s) may be configured with different A-PDCH from different RRHs.

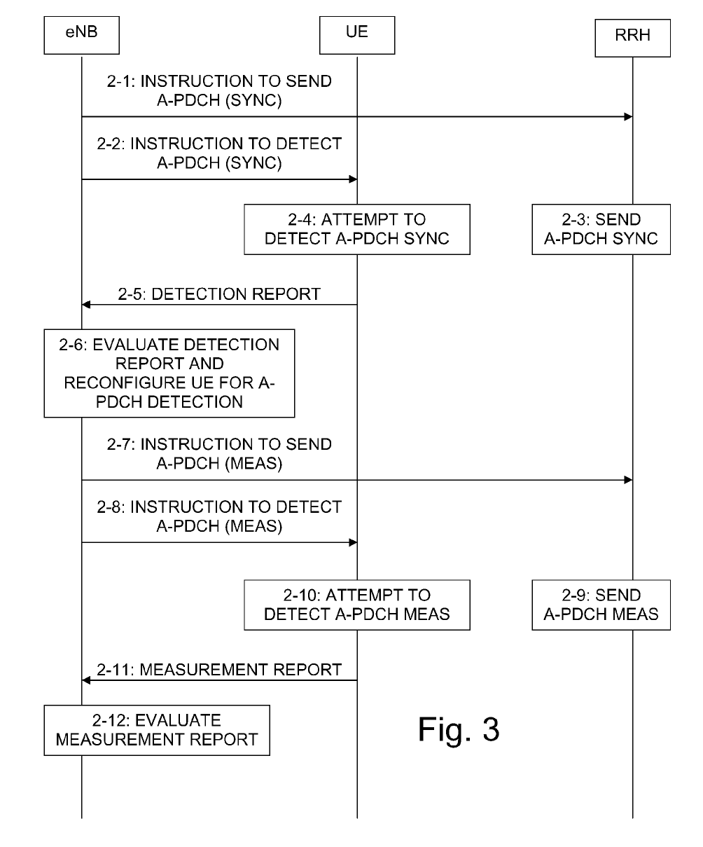

An example for the above two-stage aperiodical PDCH design is described by referring to FIG. 3.

Stage 1 is started in 2-1, in which the eNB sends an instruction to the RRH, by which the RRH is instructed to send an A-PDCH with SYNC part only, which is an example for a detection enabling signal. In 2-2, the eNB instructs the UE to detect the A-PDCH with SYNC part only. In 2-3, the RRH sends the A-PDCH, and in 2-4, the UE attempts to detect the A-PDCH. In 2-5, the UE sends a detection report to the eNB, wherein the report basically only indicates whether the UE was able to receive the A-PDCH sent by the RRH or not.

Stage 2 is started with 2-6, in which the eNB evaluates the detection report and reconfigures the UE for the A-PDCH detection. In particular, here the eNB may select some UEs and/or some RRHs by means of which further measurements in stage 2 should be carried out. In 2-7, the eNB instructs the RRH to send A-PDCH with a MEAS part (as an example for a measurement enabling signal), and in 2-8 the eNB instructs the UE to detect the A-PDCH. In 2-9, the RRH sends the A-PDCH, and in 2-10, the UE attempts to the detect it. In 2-11, the UE sends a measurement report to the eNB, and in 2-12 the eNB evaluates this.

In the following, some examples for a technical implementation of the above measures are described.

According to a first example, triggers of the aperiodical PDCH are described.

Aperiodical PDCH could be triggered based on a decision of the eNB or could be based on UE's assistant information.

In the following, a case 1 is described, in which the decision whether to trigger an A-PDCH or not is made based on UE's assistant information.

In particular, the UE detects one RRH based on Release 8 signaling (i.e. PSS/SSS, CRS, . . . ). Then, the UE reads its neighbor RRH list on the detected RRH cell, and reports this to eNB. In response to this report, the eNB generates A-PDCH for those RRHs in the list. The neighbor RRH cells may not have Release 8 signaling, hence there is now a need for the A-PDCH for SCell discovery.

Furthermore, the UE may send a report to the eNB when RSRP falls into certain threshold(s) range on the detected RRH cell. In response to such a report, the eNB may generate A-PDCH for neighboring RRHs which are within the RSRP threshold range at certain distance from macro eNB.

In the following, a case 2 is described, in which the decision whether to trigger an A-PDCH or not is made by the eNB.

In detail, the eNB roughly estimates the DoA (direction of arrival) of certain UE(s), and then generates A-PDCH for a cluster RRHs, i.e., for a certain group of RRHS, within a fixed beam range.

The eNBs knows exactly the location of the UEs via certain localization method, and then may generates A-PDCH for nearby RRHs.

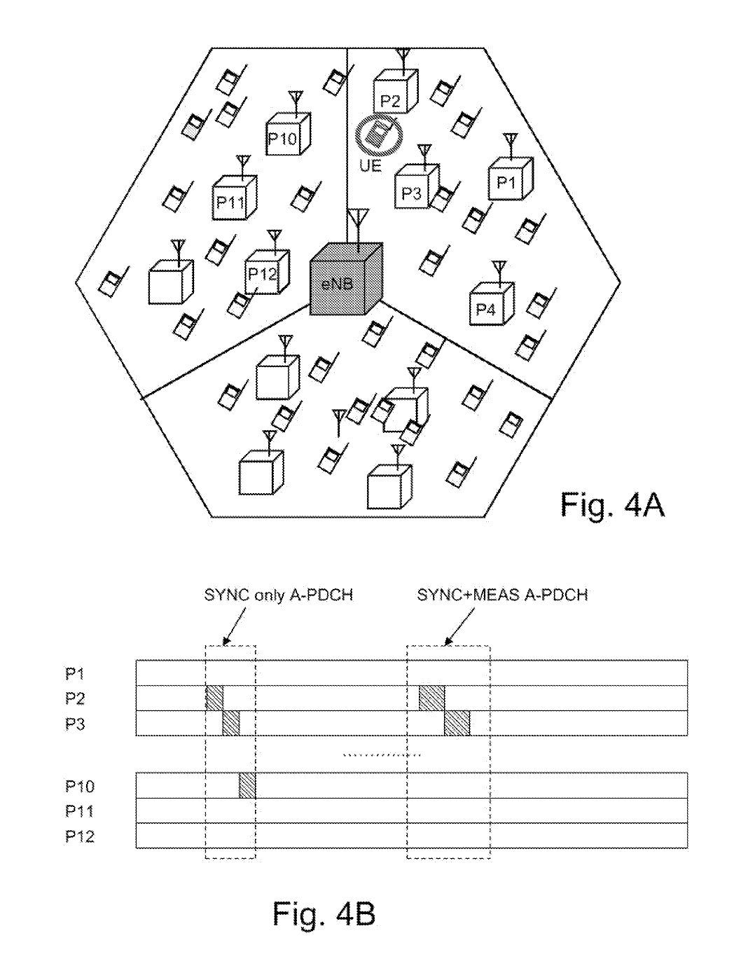

In the following, an example for an implementation of the two-stage A-PDCH is described by referring to FIGS. 4A and 4B.

FIG. 4A shows an example for cell controlled by a macro eNB, wherein several RRHs (also referred to as pica node) are provided, of which some are indicated by reference signs, namely P1, P2, P3, P4, P10, P11, P12) in order to explain the procedure. Furthermore, a plurality of UEs is present, wherein the following it is referred in particular to the UE encircled in the FIG. 4A.

In stage 1, the eNB (macro eNB) configures the RRH P2, P3, and P10 to send SYNC part only of A-PDCH, as shown in FIG. 4B. The A-PDCH with only SYNC part is indicated here with “SYNC only A-PDCH”. The UE(s) is/are configured to detect this A-PDCH, and quickly feedback the detectable RRHs. In this example for the encircled UE, these are RRH P2 and P3.

In stage 2, the macro eNB configures RRH P2 and P3 to send SYNC+MEAS A-PDCH, or MEAS part only A-PDCH to certain UE(s). In the right part of FIG. 4, the A-PCH with SYNC and MEAS parts is indicated as “SYNC+MEAS A-PDCH”. The UE(s) configured to detect/measure only RRH P2, P3. This is illustrated as in FIG. 4B. As shown, in this way, the power consumption is reduced greatly without sacrificing reliability/accuracy.

In the following, an example for a joint usage of periodical PDCH and aperiodical PDCH is described.

Namely, as discussed in the introductory part of the present specification, periodical PDCH may be sent in very large periodicity, which may be a few seconds. The pattern used for this can be pre-configured, and therefore known to UEs. The offset may be linked to some known timestamp like SFN of Macro cell, Pico's PCI, etc. This periodical PDCH could be used jointed with aperiodical PDCH by UE.

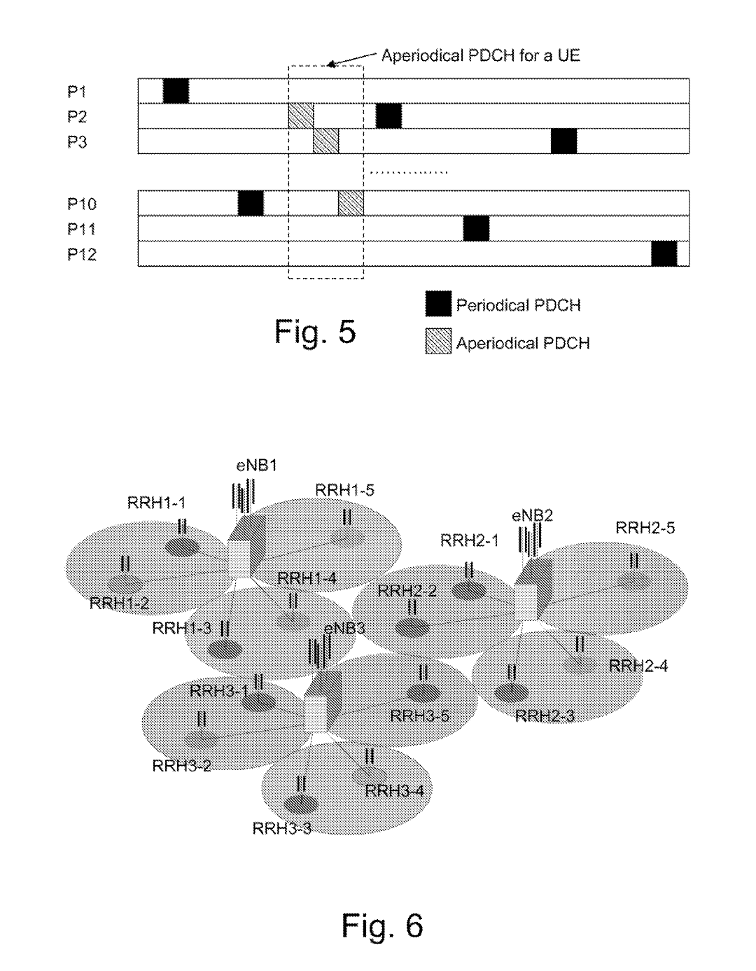

This is shown in FIG. 5. For example, some RRHs could be configured to send periodical PDCH, whereas other RRHs could be configured to send aperiodical PDCH only when needed.

In the following, a signaling format design for A-PDCH and two-stage A-PDCH is described.

The A-PDCH transmission pattern can be implicitly linked to the SCell index of RRHs for UE(s) using some mask, SCell-index-mask, on some LSB bits and predefined A-PDCH transmission pattern set, Xi, for the set of RRHs within the UE range. The set Xi allows different pre-configured A-PDCH transmission patterns to be used in case A-PDCH has some repetition to increase detection probability that may be based on the AoA+TA as measured on the PCell. The mask on the SCell index of these RRHs uniquely identify the A-PDCH transmission pattern starting from some indicated SFNx value for a given set Xi.

Thus, the dedicated signaling on PCell to trigger A-PDCH can be reduced to:
SCell index of the RRHs,
The A-PDCH transmission pattern set Xi, (maybe preconfigured)
The SCell-index-mask
The A-PDCH start timing, SFNx.

Similar way can be used for A-PDCH with SYNC and/or MEAS parts. In the above example described in connection with FIG. 5, the PCell indicates the SCell index of RRH P2, P3, and P10 where A-PDCH with SYNC will be transmitted and the pre-configured A-PDCH transmission pattern set Xi (P1, P2, P3, P4 . . . P10).

Some grouping of UEs could be considered to reduce overhead further in case many UEs per pico/RRH cells depending on their range and if used in a hot spot. For example there could be more than one UE geographically closed which could be configured the same A-PDCH (i.e. SCell index, A-PDCH configuration set Xi, and SFNx value) for RRH P2, P3, P10 or perhaps just RRH P2, P3.

Thus, according to the embodiments described above, an aperiodical PDCH transmission has been described by which a predetermined aperiodic signal (e.g., for carrying out measurements of an UE with respect to a network node such as a RRH or a pico node) is not sent periodically but only when needed.

In this way, the eNB can provide a faster access to UE in order to carry out detection and measurement without sacrifice the gain achieved from PDCH with large periodicity.

Moreover, the eNB using two-stage A-PDCH can filter out not relevant RRHs in the second stage, in order to transmit measurement part only for relevant ones, so to save power/energy/time of UE.

Furthermore, according to the embodiments described above, a flexibility to support all kinds of configuration based on information available is provided.

It is noted that the invention is not limited to the specific embodiments as described above.

For example, the predetermined aperiodic signal is not limited to the A-PDCH described above, but can be any kind of signal which is suitable for carrying out measurements, e.g., which can be sent from a slave network node and can be detected by an user equipment.

Embodiments of the present invention may be implemented in software, hardware, application logic or a combination of software, hardware and application logic. The software, application logic and/or hardware generally, but not exclusively, may reside on the devices' modem module. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

The present invention relates in particular but without limitation to mobile communications, for example to environments under LTE, WCDMA, WIMAX and WLAN and can advantageously be implemented in user equipments or smart phones, or personal computers connectable to such networks. That is, it can be implemented as/in chipsets to connected devices, and/or modems or other modules thereof.

If desired, at least some of different functions discussed herein may be performed in a different order and/or concurrently with each other. Furthermore, if desired, one or more of the above-described functions may be optional or may be combined.

According to aspects of embodiments of the present invention, an apparatus and a method is provided by which it is determined that at least one user equipment should perform detection and/or measurements with respect to at least one network control node, the at least one network control node is instructed to send a predetermined aperiodic signal to the at least one user equipment, and the at least one user equipment is instructed to detect the predetermined aperiodic signal.

According to a further aspect of embodiments of the present invention, an apparatus is provided which comprises means for determining that at least one user equipment should perform detection and/or measurements with respect to at least one network control node; means for sending instruction to the at least one network control node to send a predetermined aperiodic signal to the at least one user equipment; and means for sending instruction to the at least one user equipment to detect the predetermined aperiodic signal.

According to another aspect of embodiments of the present invention, an apparatus is provided which comprises means for receiving an instruction from a network control node to send a predetermined aperiodic signal to at least one user equipment; and means for sending the predetermined aperiodic signal to at the least one user equipment.

According to a still further aspect of embodiments of the present invention, an apparatus is provided which comprises means for receiving an instruction to detect a predetermined aperiodic signal sent by a network control node; and means for attempting to detect the predetermined aperiodic signal.

It is to be understood that any of the above modifications can be applied singly or in combination to the respective aspects and/or embodiments to which they refer, unless they are explicitly stated as excluding alternatives.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus comprising
at least one processor, and
at least one memory including computer program code,
the at least one memory and the computer program being configured to, with the at least one processor, cause the apparatus to
determine that at least one user equipment should perform detection and/or measurements with respect to at least one network control node,
send instruction to the at least one network control node to send a predetermined aperiodic signal to the at least one user equipment, and
send instruction to the at least one user equipment to detect the predetermined aperiodic signal.

2. The apparatus according to claim 1, wherein the instruction to the at least one network control node and the instruction to the at least one user equipment comprise time and duration of the predetermined aperiodic signal.

3. The apparatus according to claim 1, wherein
a plurality of user equipments is present, and
the at least one memory and the computer program are configured to, with the at least one processor, cause the apparatus to
select user equipments of the plurality of user equipments which should perform the measurements, and
send the instruction to the selected user equipments.

4. The apparatus according to claim 1, wherein
a plurality of network control nodes is present, and
the at least one memory and the computer program are configured to, with the at least one processor, cause the apparatus to
select network control nodes of the plurality of network control nodes which should send the predetermined aperiodic signal, and
send the instruction to the selected network control nodes.

5. The apparatus according to claim 1, wherein the at least one memory and the computer program are configured to, with the at least one processor, cause the apparatus to
perform the determination that the at least one user equipment should perform detection and/or measurements with respect to the at least one network control node based on assistant information of user equipments, measurements performed by the apparatus, and/or location information of the at least one user equipment.

6. The apparatus according to claim 1, wherein the instruction to the at least one user equipment comprises to perform detection with respect to the at least one network control node by determining only whether it can detect the predetermined aperiodic signal or not.

7. The apparatus according to claim 6, wherein
the instruction to the at least one network control node comprises to send a detection enabling signal as the predetermined aperiodic signal to the at least one user equipment.

8. The apparatus according to claim 1, wherein the at least one memory and the computer program are configured to, with the at least one processor, cause the apparatus to
receive detection results from the at least one user equipment,
send, after receiving the detection results, second instruction to the at least one network control node to send a measurement enabling signal as the predetermined aperiodic signal to the at least one user equipment, and
send second instruction to the at least one user equipment to perform measurement on the measurement enabling signal as the predetermined aperiodic signal.

9. The apparatus according to claim 8, wherein a plurality of user equipments is present, and
the at least one memory and the computer program are configured to, with the at least one processor, cause the apparatus to
select user equipments from the plurality of user equipments to which the second instruction is to be sent based on the received detection results, and
send the second instruction to the selected user equipments.

10-19. (canceled)

20. A method comprising
determining that at least one user equipment should perform detection and/or measurements with respect to at least one network control node,
sending instruction to the at least one network control node to send a predetermined aperiodic signal to the at least one user equipment, and
sending instruction to the at least one user equipment to detect the predetermined aperiodic signal.

21. The method according to claim 20, wherein the instruction to the at least one network control node and the instruction to the at least one user equipment comprise time and duration of the predetermined aperiodic signal.

22. The method according to claim 20, wherein
a plurality of user equipments is present, and the method further comprises
selecting user equipments of the plurality of user equipments which should perform the measurements, and
sending the instruction to the selected user equipments.

23. The method according to claim 20, wherein
a plurality of network control nodes is present, and the method further comprises selecting network control nodes of the plurality of network control nodes which should send the predetermined aperiodic signal, and
sending the instruction to the selected network control nodes.

24. The method according to claim 20, further comprising
performing the determination that the at least one user equipment should perform detection and/or measurements with respect to the at least one network control node based on assistant information of user equipments, measurements performed by the apparatus, and/or location information of the at least one user equipment.

25. The method according to claim 20, wherein the instruction to the at least one user equipment comprises to perform detection with respect to the at least one network control node by determining only whether it can detect the predetermined aperiodic signal or not.

26. The method according to claim 25, wherein
the instruction to the at least one network control node comprises to send a detection enabling signal as the predetermined aperiodic signal to the at least one user equipment.

27. The method according to claim 20, further comprising
receiving detection results from the at least one user equipment,
sending, after receiving the detection results, second instruction to the at least one network control node to send a measurement enabling signal as the predetermined aperiodic signal to the at least one user equipment, and
sending second instruction to the at least one user equipment to perform measurement on the measurement enabling signal as the predetermined aperiodic signal.

28. The method according to claim 27, wherein a plurality of user equipments is present, and the method further comprises
selecting user equipments from the plurality of user equipments to which the second instruction is to be sent based on the received detection results, and
sending the second instruction to the selected user equipments.

29-39. (canceled)

40. A non-transitory computer readable memory comprising a set of computer instructions stored thereon, which, when executed by a device, cause the device to
determine that at least one user equipment should perform detection and/or measurements with respect to at least one network control node,
send instruction to the at least one network control node to send a predetermined aperiodic signal to the at least one user equipment, and
send instruction to the at least one user equipment to detect the predetermined aperiodic signal.

41. The non-transitory computer readable memory according to claim 39, wherein the instruction to the at least one network control node and the instruction to the at least one user equipment comprise time and duration of the predetermined aperiodic signal.
